(19) United States
(12) Patent Application Publication
(10) Pub. No.: US 2015/0208707 A1
(43) Pub. Date: Jul. 30, 2015

(54) BAKED PRODUCT

(71) Applicant: BRIU GmbH, Koenigstein (DE)

(72) Inventor: Uwe-Bernd Rose, Koenigstein (DE)

(73) Assignee: BRIU GMBH, Koenigstein (DE)

(21) Appl. No.: 14/421,497

(22) PCT Filed: Jun. 19, 2013
(86) PCT No.: PCT/EP2013/062754

§ 371 Date: Feb. 13, 2015

(30) Foreign Application Priority Data
Aug. 15, 2012 (DE) 10 2012 214 537.0

(51) Int. Cl. A23L 1/29

(52) U.S. Cl. CPC A23L 1/293; A23V 2002/00

(57) ABSTRACT

The subject matter of the invention is a dough for the production of a baked product, containing flour, fat, and sweetener. According to the invention, the flour fraction contains at least 10% by weight of Jerusalem artichoke flour, and the dough contains at least 1% by weight, with respect to its total mass, of a flavor carrier for the purpose of disguising the flavor of cynarin. A baked product which can be obtained by baking this dough is also the subject matter of the invention.

The invention relates to a dough for the production of a baked product, containing flour, fat, and sweetener. A baked product, and particularly cookies, which can be obtained by baking this dough is also the subject matter of the invention.

Baked products such as cookies are well-known from public prior use.

DE 198 30 122 A1 discloses a bread recipe using Jerusalem artichoke as an ingredient, intended to be added in fresh form as the Jerusalem artichoke vegetable, as Jerusalem artichoke syrup, or as Jerusalem artichoke liqueur. The use of Jerusalem artichoke flour is not disclosed.

DE 101 19 732 A 1 discloses a dough which is intended to provide a supply of essential amino acids by means of a combination of certain ingredients. Jerusalem artichoke is mentioned as a possible ingredient.

DE 38 15 950 C2 discloses a baked good using Jerusalem artichoke. The steaming of the Jerusalem artichoke tuber, processing of the same into a puree, and the mixing of this puree with wheat flour to produce a dough is described therein.

U.S. Pat. No. 3,497,360 discloses a bread which is baked with the addition of 5.7-7.5% Jerusalem artichoke flour.

The problem addressed by the invention is that of creating a baked product of the type named above, based on natural ingredients, which has an appetite suppressing effect and which is acceptable to the senses and taste of the consumer.

This problem is addressed, with regards to a dough for the production of a baked product of the type named above, in that the flour fraction contains at least 10% by weight of Jerusalem artichoke flour, the dough contains at least 1% by weight, with respect to its total mass, of a flavor carrier for the purpose of disguising the flavor of cynarin, and in that it contains 0.5-5% by weight of silica gel or silicon dioxide. Below, several terms used in the context of the invention will be explained.

A baked product is an edible, baked food, particularly a dough-based pastry such as cookies or the like. The term “flour” indicates any and all flours commonly used for the production of foods, such as wheat, rye, or spelt flours, by way of example, and including the Jerusalem artichoke flour used according to the invention.

Fats can be of plant or animal origin. By way of example, vegetable fats, margarines, butter, and butter fats are hereby named. Sweeteners can particularly be various sugars or sugar derivatives, or other sweeteners such as Stevia, for example.

According to the invention, the flour fraction contains at least 10% by weight of Jerusalem artichoke flour. Therefore, of the total amount of flour used, at least 10% by weight is allotted to the Jerusalem artichoke flour. The Jerusalem artichoke plant contains inulin, which is known to be an appetite suppressing agent in the prior art. By means of the Jerusalem artichoke flour, it is possible to introduce inulin into the baked product in a form based on a natural material.

The invention recognizes that Jerusalem artichoke flour can introduce an undesirable bitter flavor into the baked product, due to the bitter agent cynarin contained in the Jerusalem artichoke plant. This bitter flavor is somewhat like that of an artichoke (cynarin is likewise present in artichokes).

Therefore, according to the invention, the dough additionally contains at least 1% by weight with respect to its total mass of a flavor carrier, for the purpose of disguising the flavor of cynarin. In the context of this invention, such a flavor carrier is suitable for disguising the undesirable artichoke flavor produced in the finished baked product by cynarin to such an extent that it is no longer perceived as unpleasant by the consumer.

Consequently, the core of the invention is the introduction of appetite suppressing inulin in a form based on a natural material (Jerusalem artichoke flour) into a baked product, on the one hand, while on the other hand, to have recognized the disadvantageous consequences associated therewith, and to compensate for these by the addition of a corresponding flavor carrier.

The flavor carrier can preferably be selected from the group consisting of fruit syrups, condensed fruit juices, fruit juices, and hazelnut syrup. All of these flavor carriers possess the property of disguising and/or compensating for the undesirable flavor fraction of the Jerusalem artichoke flour caused by cynarin, on the one hand, while on the other hand, they advantageously contribute to the flavor of the baked product. In the context of the invention, such a flavor carrier can also function as a sweetener at the same time, because condensed fruit juices contain sugar, by way of example. Of the condensed fruit juices and syrups, condensed apple or pear fruit juices, by way of example, are suitable.

According to the invention, the flour fraction preferably contains 10 to 40% by weight, and further 15 to 30% by weight, and more preferably 15 to 25% by weight of Jerusalem artichoke flour. In this way, it is possible to introduce an amount of inulin into the baked product which is relevant for the appetite suppressing function. At the same time, the flavor thereof is not compromised for the consumer, or at least is compromised in an acceptable manner.

With respect to the total mass of the dough, the same can contain 4 to 20% by weight, and more preferably 5 to 15% by weight, and still more preferably 6 to 12% by weight of Jerusalem artichoke flour.

The fraction of the flavor carrier in the total mass of the dough is preferably 1 to 6% by weight, and more preferably 2 to 5% by weight.

Inulin is not digested in the gastrointestinal tract of most people. However, in approximately a fifth of all people, the intestinal flora contains enzymes which are able to digest inulin. This digestion process can lead to flatulence.

The dough therefore additionally contains means to counteract flatulence, said means being selected from the group consisting of silicic acid and silicic acid derivatives—more preferably silicon dioxide or silica gels. The dough preferably contains 0.5 to 5% by weight, and more preferably 1 to 3% by weight of silicon dioxide or silica gels.

Vegetable fats are preferred as the fat in the baked product and/or dough used for the production of the same according to the invention. Flour and fat are generally the primary components of the dough. The fraction of the flour in the total mass of the dough can be 30 to 60% by weight according to the invention, and preferably 40 to 50% by weight, by way of example. The fraction of the fat in the total mass of the dough can be 10 to 30% by weight, by way of example, and more preferably 15 to 30% by weight, and still more preferably 20 to 25% by weight.

The sweeteners can preferably be selected from the group consisting of sugars and other high-sugar content products such as honey, for example. The dough can preferably contain other common ingredients of a cookie dough, such as eggs, and optionally milk or a small amount of salt, for example.

A baked product which can be obtained by baking a dough according to the invention is also the subject matter of the invention. In particular, this can be a cookie.

Embodiments of the invention are described below.

### EXAMPLE 1

The following ingredients are stirred to create a dough:

320 g wheat flour

80 g Jerusalem artichoke flour

100 g honey

10 g vanilla sugar

0.5 g salt

2 eggs

200 g vegetable fat

5 g milk

20 g silica gel

25 g of condensed pear juice

Approximately 50 cookies are produced and baked from the dough created as above.

### EXAMPLE 2

The dough in example 1 is prepared with the same ingredients, with an additional 10 g cocoa added as a further flavor carrier.

### EXAMPLE 3

The dough in example 1 is prepared with the same ingredients, plus an additional 10 g of cinnamon powder.

### EXAMPLE 4

Execution of a Score Test

The cookies baked according to example 1 are offered to ten test persons, and the same are asked to report various sensory characteristics and appetite-influencing properties using a questionnaire. The score test showed the following results:

1. Sensory

| | Very | | | | |
|---|---|---|---|---|---|
| | good | acceptable | neutral | moderate | poor |
| Appearance | 1 | 8 | | 1 | |
| Smell | 6 | 3 | 1 | | |
| Flavor | 2 | 4 | 4 | 1 | |
| Consistency | 5 | 3 | 1 | | |
| Overall impression | 3 | 6 | 1 | | |

2. Effect

| | | | don't |
|---|---|---|---|
| | yes | no | know |
| Did eating this have an influence on your appetite? | 8 | 1 | 1 |
| Did you have negative side-effects? | 1 | 9 | |
| Did eating this influence your other eating behaviors? | 5 | 4 | 1 |
| Did the amount consumed influence your state of health? | 2 | 7 | 1 |

3. Overall evaluation

| | | | don't |
|---|---|---|---|
| | yes | no | know |
| Does the product make a positive | 9 | | 1 |
| impression on you as a consumer? | | | |
| Would you buy a product like this? | 5 | 2 | 3 |

It can be seen from the score test that the cookie according to the invention is overwhelmingly judged positively, and that 8 out of 10 test persons perceived an influence on their appetite.

1. A dough for the production of a baked product, containing:
flour;
fat;
sweetener;
characterized in that the flour fraction contains at least 10% by weight of Jerusalem artichoke flour, and in that the dough contains:
a. at least 1% by weight of a flavor carrier for the purpose of disguising the flavor of cynarin;
b. 0.5-5% by weight of silica gel or silicon dioxide with respect to its total mass.

2. A dough according to claim 1, characterized in that the flavor carrier for the purpose of disguising the flavor of cynarin is selected from the group consisting of fruit syrups, condensed fruit juices, fruit juices, and hazelnut syrup.

3. A dough according to claim 1, characterized in that the flour fraction contains 10 to 40% by weight of Jerusalem artichoke flour.

4. A dough according to claim 1, characterized in that it contains 4 to 20% by weight of Jerusalem artichoke flour with respect to its total mass.

5. A dough according to claim 1, characterized in that it contains 1 to 6% by weight of a flavor carrier for the purpose of disguising the flavor of cynarin.

6. A dough according to claim 1, characterized in that it contains 1 to 3% by weight of silicon dioxide or silica gel.

7. A dough according to claim 1, characterized in that it contains vegetable fat.

8. A dough according to claim 1, characterized in that the sweetener is selected from the group consisting of sugars and honey.

9. A dough according to claim 1, characterized in that it additionally contains at least one of eggs and milk.

10. A baked product which can be obtained by baking a dough according to claim 1.

11. A baked product according to claim 10, characterized in that it is a cookie.

12. A dough according to claim 3, characterized in that the flour fraction contains 15 to 30% by weight of Jerusalem artichoke flour.

13. A dough according to claim 12, characterized in that the flour fraction contains 15 to 25% by weight of Jerusalem artichoke flour.

14. A dough according to claim 4, characterized in that it contains 5 to 15% by weight of Jerusalem artichoke flour with respect to its total mass.

15. A dough according claim 14, characterized in that it contains 6 to 12% by weight of Jerusalem artichoke flour with respect to its total mass.

16. A dough according to claim 5, characterized in that it contains 2 to 5% by weight of a flavor carrier for the purpose of disguising the flavor of cynarin.
